(19) United States
(12) Patent Application Publication
(10) Pub. No.: US 2004/0039817 A1
(43) Pub. Date: Feb. 26, 2004

(54) Enhanced algorithm for initial AP selection and roaming

(76) Inventors: Mai Tranh Lee, Hawthorne, CA (US); Lun-Te Lai, South Pasadena, CA (US); Dennis Lai, Cerritos, CA (US)

Correspondence Address: Tom Chen, MacPHERSON KWOK CHEN & HEID LLP, Suite 210, 2402 Michelson Drive, Irvine, CA, 92612, US

(21) Appl. No.: 10/228,668

(22) Filed: Aug. 26, 2002

(51) Int. Cl. G06F 15/173

(52) U.S. Cl. 709/225

(57) ABSTRACT

In a wireless network, such as an 802.11 conformant wireless LAN, a wireless station selects an access point, e.g., during power-up or roaming, based on the received signal strength indicator (RSSI) and channel loading information. The RSSI information is measured by the receiving station when the beacon or probe response frame is received, and the channel loading information is communicated to the station through the beacon or probe response frames. The channel loading information is a percentage of time the access point is busy transmitting or receiving data during a reporting interval. By using both RSSI and channel loading information, performance is increased when the access point with the strongest signal is also the busiest. In this case, this access point would not be selected for association with the wireless station.

### BACKGROUND OF THE INVENTION

1. Field of the Invention

The present invention relates to access point (AP) selection in wireless network systems, and more particularly to access point (AP) selection in IEEE 802.11 (WLAN) systems that provides channel utilization indicator and signal strength measurement capabilities or other similar functionalities.

2. Discussion of the Related Art

Wireless local area networks (WLANs), which can be a specific physical site, such as an office building, or an area, allow wireless users or stations to communicate with other stations within the LAN. In a typical network, a LAN has a plurality of Basic Service Sets (BSSs), with each BSS typically having a base station or an access point (AP) connected to a wired network and two or more wireless stations. Communication within the BSS, such as to other wireless stations or a file server, is provided through the AP. In this case, stations are required to associate with an AP in order to gain access to the network. Thus, initially when a station decides to join the network, it would need to search for an AP to associate with before any delivery of data is allowed. During the course of data transmission after the association, a wireless station may move or “roam” out of the coverage area associated with its current AP. In this case, it must associate itself with a new AP in order to communicate within the LAN. When roaming, the wireless station maintains connection with its current AP. APs are located throughout the LAN, with each BSS typically having overlapping coverage with other BSSs, so that the wireless stations can roam from one area to another within the LAN and maintain communication anywhere in the LAN. APs also allow communication between wireless stations in different BSSs through corresponding APs.

When roaming or during initial station-to-AP association phase, the wireless station must identify and associate with a suitable access point. However, since the LAN may have numerous APs to choose from, networks utilize various algorithms for selecting an access point. For example, with wireless networks conforming to the IEEE 802.11 standard, APs, either periodically or upon request, send a beacon or a response frame that carries information such as network loading. Stations receiving these frames measure the received signal strength indicator (RSSI). The RSSI value represents the signal strength of the beacon or the response frame received by the station. Although the IEEE 802.11 specification provides beacon transmission that allows stations to discover the existence of APs in the network and provides the basic frame types to support association service between the station and AP, it does not actually set the AP selection algorithm. Using the RSSI value, conventional algorithms select the AP with the strongest signal.

There are two ways for a wireless station to scan for existing APs, active scanning and passive scanning. For active scanning, the wireless station sends out a probe frame on specific channels (the same channel and/or different channels) to solicit response frames from APs in the area. For passive scanning, the wireless station “listens” for beacon frames, which are transmitted periodically by APs. Once the wireless station finds the AP with the strongest signal, the wireless station sends a request to that AP for association. The AP then transmits an acknowledgement and acceptance of the request. This selection can be done when a wireless station enters the network, moves to another cell, or stays in the same cell but tries to associate with a different AP because the existing connection has weakened. Bad connections can result from low signal strength and poor signal quality, which can lead to high packet error rates and low network throughput of the wireless station.

However, selection algorithms based only on RSSI values do not always select the AP that results in the best communication and/or throughput. For example, a wireless station has received information (e.g., contained in beacon or response frames) from three potential access points, AP₁, AP₂, and AP₃, with which to associate. If AP₂ has the highest RSSI value, AP₂ is selected, and a connection is established. However, AP₂ may also be maintaining connection with a large number of other wireless stations, resulting in a high network loading for AP₂. So, even though AP₂ has the strongest received signal, the wireless station may experience very low performance, which could initiate another scan by the wireless station for a better connection. Thus, in this case, the station will find itself consuming most of the time in searching for APs instead of transmitting useful data.

Accordingly, it is desirable to have an access point selection algorithm without the disadvantages discussed above associated with conventional algorithms.

### SUMMARY OF THE INVENTION

In accordance with the present invention, access point selection, both initially and during roaming, in a wireless LAN, such as 802.11 conformant networks, utilizes both a signal strength indicator and a channel utilization indicator. By using both indicators, the wireless station may select an access point that will provide an overall higher communication performance when factoring in both network throughput and signal quality. The channel utilization is defined as the percentage of time an access point is busy transmitting or receiving data during the reporting interval. It is calculated as the ratio between the amount of time that the access point transmits or receives data and the total utilization measuring duration.

In one embodiment of the present invention, the wireless station first acquires signal strength (e.g., RSSI) and channel loading information from all access points at the appropriate frequencies. In general, if APs exist that have channel loading less than the maximum acceptable value and signal strength greater than a first threshold, the AP having the highest signal strength is selected. If no APs meet the above criteria, the first threshold is decreased to a second threshold. If there are APs that meet this more relaxed condition, the AP having the lowest channel utilization is selected. If there are still no APs satisfying the conditions, the AP is selected having the lowest channel utilization, while having a signal strength greater than the second threshold.

More specifically, in one embodiment, if there is an operating mode configured, e.g., 802.11(a), 802.11(b), or 802.11(g), the wireless station determines whether there exists any access points in which the channel loading is below the maximum AP loading that the station can tolerate (e.g., still meet its QoS) and having an RSSI value greater than or equal to −62 dBm. If so, then the AP with the lowest channel loading is selected. However, if these conditions are not met, the wireless station determines whether any AP exists that still meet the earlier threshold requirement, but having an RSSI value greater than or equal to −82 dBm. If so, then the wireless station selects the AP with the highest associated signal strength. If these second set of conditions are still not met, the AP having the lowest channel loading, while still having a signal strength greater than −82 dBm is selected. If no APs have signal strength greater than −82 dBm, none is selected.

In the present invention, the wireless station uses the network (channel) loading information as well as the signal strength information to select an AP that not only provides high signal quality but also meets the QoS requirements and at the same time optimizes the network throughput.

This invention will be more fully understood in light of the following detailed description taken together with the accompanying drawings.

### BRIEF DESCRIPTION OF THE DRAWINGS

FIG. 1 is a flow chart showing one embodiment of the invention for initial access point (AP) selection;

FIG. 2 is a flow chart showing one embodiment of the active scanning step of FIG. 1;

FIG. 3 is a flow chart showing one embodiment of the passive scanning step of FIG. 1;

FIG. 4 is a flow chart showing one embodiment of the AP selection step of FIG. 1;

FIG. 5 is a flow chart showing one embodiment for joining an AP from FIG. 1;

FIG. 6 is a flow chart showing one embodiment of the invention for AP selection during roaming;

FIG. 7 is a flow chart showing one embodiment of the AP selection step of FIG. 6; and

FIG. 8 is a diagram showing a portion of a wireless local area network suitable for implementing the present invention.

Use of the same reference numbers in different figures indicates similar or like elements.

### DETAILED DESCRIPTION

The present invention provides an algorithm for access point (AP) selection in wireless local area networks (LANs) that utilizes both the received signal strength indication (RSSI) value and the channel or network loading information. The invention is suitable for different types of wireless LANs, including those conforming to the IEEE 802.11 standard, such as 802.11(a), 802.11(b), and the working drafts such as 802.11(g) and 802.11(e) with APs having extended capability to support channel loading measurement. 802.11 conformant networks typically include a plurality of Basic Service Sets (BSSs), with each BSS having multiple wireless stations and an access point (AP). The stations can be any device that can function within the 802.11 protocol, e.g., with physical layer (PHY) interfaces to the wireless medium and Media Access Control-(MAC) that utilizes Carrier Sense Multiple Access with Collision Avoidance (CSMA/CA) protocol. Examples of suitable devices include laptop PCs and handheld devices, such as PDAs. These devices can be mobile, portable, or stationary. AP devices also contain 802.11 conformant MAC and PHY interface to the wireless medium and provide access to a distribution system for associated stations.

The present invention applies to wireless LANs having APs that can be configured to operate in 802.11(a), 802.11(b) or 802.11(g) and wireless stations that can fix their operating mode or search for the mode that provides the highest network throughput.

While there are many similarities across the various 802.11 protocols, there are also significant differences. 802.11(a) specifies a high-speed physical layer operating in the 5 GHz radio band utilizing a complex coding technique known as orthogonal frequency division multiplexing (OFDM). 802.11(a) devices can operate at eight data rates, 6, 9, 12, 18, 24, 36, 48, and 54 Mbps.

In 802.11(b), which is probably the most widely implemented and used wireless LAN technology today, devices operate in the 2.4 GHz band using direct sequence spread spectrum (DSSS) modulation. Available data rates are 1, 2, 5.5, and 11 Mbps. 802.11(g) provides networks with the high speed of 802.11(a) systems while operating in the 2.4 GHz radio band. Like 802.11(a), 802.11(g) uses OFDM, but it also supports complementary code keying (CCK) modulation for compatibility with 802.11(b) and has an option that allows packet binary convolutional coding (PBCC) modulation.

Regardless of the protocol, before a wireless station can begin communication or sending data through an AP within a wireless network, it must associate itself with an AP. A wireless station typically invokes the association service only once. e.g., when it enters a BSS or after power-up. Each station can associate with one AP, while many stations can be associated with a single AP.

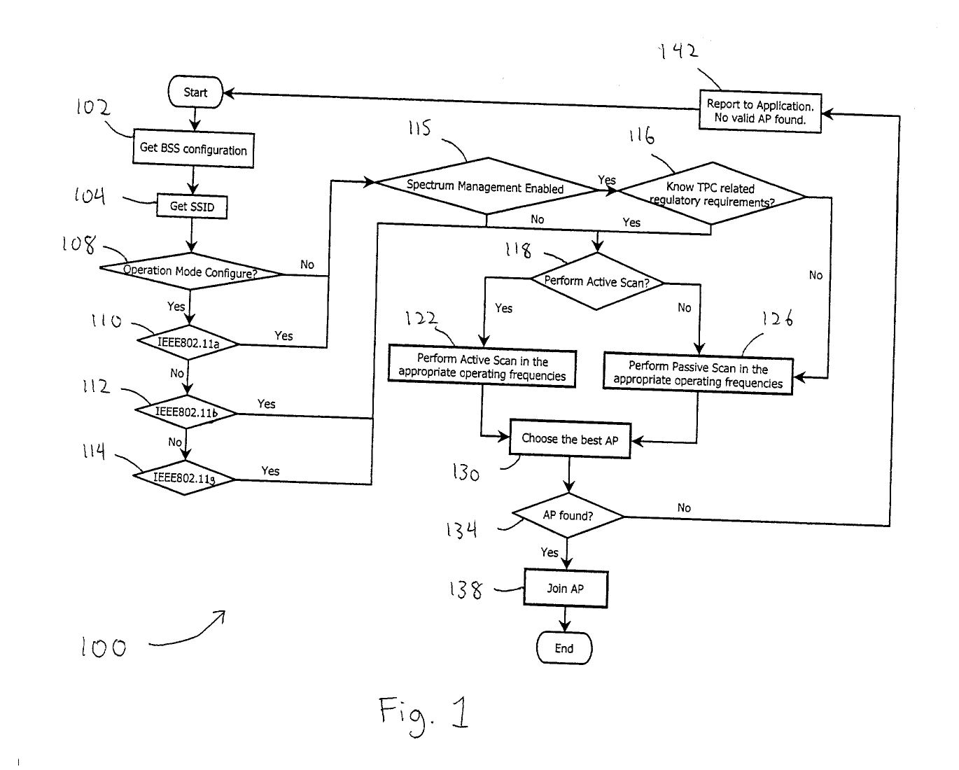

FIGS. 1-5 are flow charts showing one embodiment of the present invention. FIG. 1 is a flow chart showing a general overall process for an initial AP selection process 100. When the station enters a BSS, it gets the configuration of that BSS in step 102. For example, the BSS configuration can be an ad hoc network (or Independent Basic Service Set, IBSS), in which communication is established directly between two wireless stations, or an infrastructure mode, in which an AP in the BSS facilitates communication between wireless stations. Once the BSS configuration is obtained, the station gets the Service Set Identifier (SSID) of the BSS in step 104. If an SSID is configured, then the station only chooses APs with a matched SSID.

Next, in steps 108, 110, 112, and 114, the wireless station checks to see if a particular operating mode (i.e., 802.11 (a), 802.11 (b), 802.11 (g)) is configured for it. If there is no specific configuration, the station searches APs for all available modes. However, if the station is configured for a particular mode, the station only searches APs within that mode.

If the wireless station has not been configured for a particular operational mode (i.e., the result of step 108 is no) or the station is configured for 802.11 (a) (i.e., the result of step 110 is yes), then the wireless station determines, in step 115, whether spectrum management is enabled. In some regions, such as in Europe, operation of wireless devices in the 5 GHz band shall satisfy the related regulatory requirements (e.g., TPC and DFS) set forth by the regulatory bodies. Dynamic frequency selection (DFS) facilities are mandated to satisfy requirements in some regulatory domain for radar detection and uniform channel spreading in the 5 GHz and other purposes. Transmit power control (TPC) facilities are mandated to satisfy requirements in some regulatory domains for maximum transmit power and average transmit power mitigation in the 5 GHz band and other purposes.

In the present invention, details relating to spectrum management or TPC/DFS can be found in different documents on 802.11 spectrum management in the 5 GHz band, such as the IEEE 802.11 (h) draft 2.1 July 2002, entitled “Spectrum Management in 5 GHz band in Europe”, which is incorporated by reference in its entirety. The purpose of this potential standard is to define mechanisms for DFS and TPC that may be used to satisfy regulatory requirements for operation in the 5 GHz band in Europe.

If spectrum management is not enabled, the station determines whether the scanning mode is active or passive, in step 118. Otherwise, in step 116, the station determines whether the station knows TPC related regulatory requirements. TPC related regulatory requirements may include maximum transmit power and average power mitigation in the 5 GHz band specified by the region. The discussion of this topic is beyond the scope of this invention; those who are skilled in the art or those who would like to implement devices to support spectrum management can easily obtain the information relating to the regional regulations.

Note that at the time of this writing, 802.11 (h) is a draft and has not yet become a standard, i.e., some requirements in the draft are still not solid and are subject to change. However, this invention takes into account the main goals of 802.11 (h) by incorporating some of the basic requirements that allow implementers who want to provide 802.11 (h) capabilities to also utilize the present invention.

Referring back to FIG. 1, if the result of step 116 is no, the wireless station searches for APs by passive scanning (as will be discussed in detail below). However, if the wireless station is configured for 802.11 (b) or 802.11 (g) (i.e., the result of step 112 or 114, respectively, is yes), the result of step 115 is no, or the result of step 116 is yes, then the wireless station determines the scanning mode in step 118.

If active scanning, the station, in step 122, performs an active scan in the appropriate frequencies and obtains or measures the necessary information, i.e., received signal strength indication (RSSI) value and network or channel loading, for subsequent, access point selection.

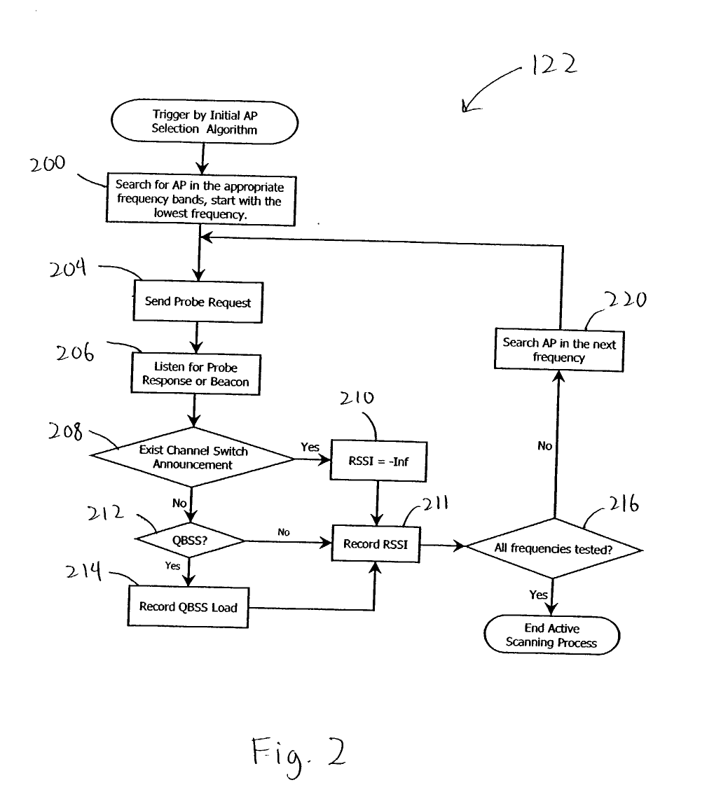

FIG. 2 is a flow chart showing one embodiment of an active scanning process 122 of FIG. 1. In step 200, the station starts the scanning at the lowest frequency. For example, for 802.11 (a), the lowest channel frequency is centered at 5.180 GHz, and for 802.11 (b), the lowest channel frequency is centered at 2.412 GHz. Since this is active scanning, in step 204, the station must first send a probe request to all APs receiving on the selected frequency channel. The probe request includes the address of the transmitting wireless station and SSID if one is configured; however, the destination address contains the broadcast BSSID (e.g., a value of all Is). Accordingly, all APs with a matched SSID receiving the probe request will respond.

After sending the probe request, the wireless station “listens” for probe responses from the APs, in step 206. The probe response contains information about the AP and communication channel, such as the address of the transmitting AP, hopping sequence, and channel loading (information embedded in the beacon or probe response frames as part of the 802.11 (e) draft specification). In step 206, the wireless station also listens for beacons sent by APs. Conformant to 802.11, APs periodically transmit beacon frames for each channel at fixed time intervals called beacon intervals. The beacons contain information similar to probe responses, such as the AP address and channel loading. Details of active scanning are well known to those skilled in the art and are not described in detail herein.

After receiving the probe response or beacon, the wireless station determines if a channel switch announcement exists in step 208. As part of the 802.11 (h) draft, the channel-switch announcement is embedded in the beacon or probe response frames to indicate to stations in the BSS that the AP is intended to move to another channel to avoid contention with radar signals. If such an announcement exists in the beacon, the station shall not attempt to associate with the AP and therefore sets the RSSI to −∞, in step 210. The RSSI value is then stored or recorded for the corresponding AP and frequency in step 211. However, if there is no channel switch announcement, the wireless station checks, in step 212, if the current BSS is a QoS BSS (QBSS), i.e., whether the AP transmitting the beacon supports 802.11 (e). If it is a QBSS, then the QBSS_Load value is recorded. The QBSS_Load value represents the traffic load within the BSS, and this information is contained in the probe response or beacon frames received from the APs.

The QBSS_Load value indicates the channel utilization or loading of the AP. In one embodiment, QBSS_Load is calculated according to equation (1) below.

$$QBSS\_Load = \frac{Busy Duration}{Measurement Duration} \qquad ( 1 )$$

Busy Duration is the amount of time the AP transmits or receives traffic, and Measurement Duration is the total channel utilization measurement duration. The default value for the Measurement Duration is a beacon interval, with a typical value being 100 ms. Note that equation (1) is a different way to calculate channel utilization than the definition provided by IEEE 802.11 (e) (draft 2.0), which calculates the ratio of the number of utilized bits per second (bps) to the total number of available bps. However, a problem with this definition is that it is hard to quantify the total available bps during the idle period when no data is being received since the stations can be transmitting in any of the available data rates. Equation (1) does not rely on the data rate information from the idle period, rather it is dependent only on the busy period and the total measurement duration. Note that other indications of channel utilization or loading may also be suitable, depending on system requirements.

The channel loading number (or QBSS_Load value) is between 0 and 1, or expressed as a percentage, between 0 and 100%. Thus, a channel loading of near 100% indicates that the AP is almost fully utilized, and any new stations trying to join that AP will experience poor performance due in part to low network throughput, even though the received signals may still be strong. On the other hand, a channel loading of near 0 indicates that not many stations are processing data through that AP, and thus, the AP is under-utilized.

Referring back to step 212, if the result of step 212 is no, the wireless station records the RSSI value in step 211. If the result of step 212 is yes, the station first records the QBSS_Load value in step 214 before recording the RSSI value in step 211. The RSSI value is typically given in dBm.

After storing addresses, RSSI values, and channel loading information of the APs in the selected frequency channel, the wireless station, in step 216, determines if there are additional frequencies that have not been checked. If all the frequencies have been checked, the algorithm ends the active scanning routine and uses the acquired information to select the best AP for association in step 130 (FIG. 1). However, if all the frequencies have not been checked, the wireless station checks the next lowest frequency in step 220. The wireless station measures the RSSI and obtains the address and channel loading information for all the receiving beacon and probe response frames.

For example, with 802.11 (a) networks, there are 12 frequency channels, with each channel being 20 MHz wide and centered at 20 MHz intervals (beginning at 5.180 GHz and ending at 5.320 GHz for the lower and middle U-NII bands and beginning at 5.745 GHz and ending at 5.805 GHz for the upper U-NII band). With 802.11 (b) networks, there are 14 frequency channels (1-11 in North America, 1-13 in most of Europe, and 14 in Japan). Each channel is 22 MHz wide and centered at 5 MHz intervals beginning at 2.412 GHz and ending at 2.462 GHz for the North American channels. Thus, several channels overlap each other in the spectrum. So, with devices in an 802.11 (b) network, the wireless station next checks the channel with a center frequency of 2.417 GHz.

After the last frequency channel is checked, the wireless station determines the best AP in step 130 (FIG. 1).

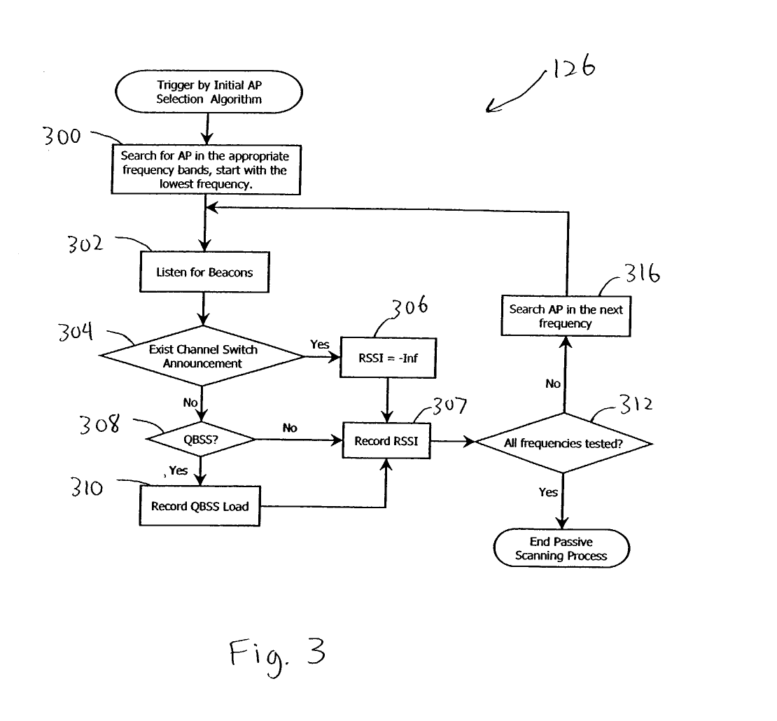

Returning back to FIG. 1, step 118, if the scanning is passive, the wireless station performs a passive scan in step 126 to measure RSSI value and to acquire the address and channel loading information (or QBSS_Load value) of each AP at the operating frequencies. FIG. 3 is a flow chart showing one embodiment of passive scanning process 126 of FIG. 1. In step 300, the station starts the passive scanning at the lowest frequency of the network. Since the scanning is passive, the wireless station does not send out probe requests as with the active scanning described above. Instead, in step 302, the wireless station listens for beacon frames that are transmitted periodically by the APs. As with active scanning, details of passive scanning are well known to those skilled in the art and are not described in detail herein.

Similar to the active scanning (steps 208, 210, 211, 212 214), the wireless station determines if a channel switch announcement exists (in step 304) and if a QBSS_Load value is stored (in step 308). Depending on the results, prior to storing the RSSI value (in step 307), the RSSI is set to −∞ (step 306), left unchanged, or the QBSS_Load value is first stored (step 310).

If the wireless stations determines, in step 312, that all frequencies have been checked, the process for selecting the best AP begins in step 130 (FIG. 1). However, if not all the frequency channels have been scanned, then the wireless station checks for beacons at the next lowest frequency channel in step 316. This process continues until the wireless station has stored the address, RSSI value, and channel loading information (or QBSS_Load value) for all APs in the network. Once this is completed, the wireless station selects the best AP in step 130 (FIG. 1) based on the stored information.

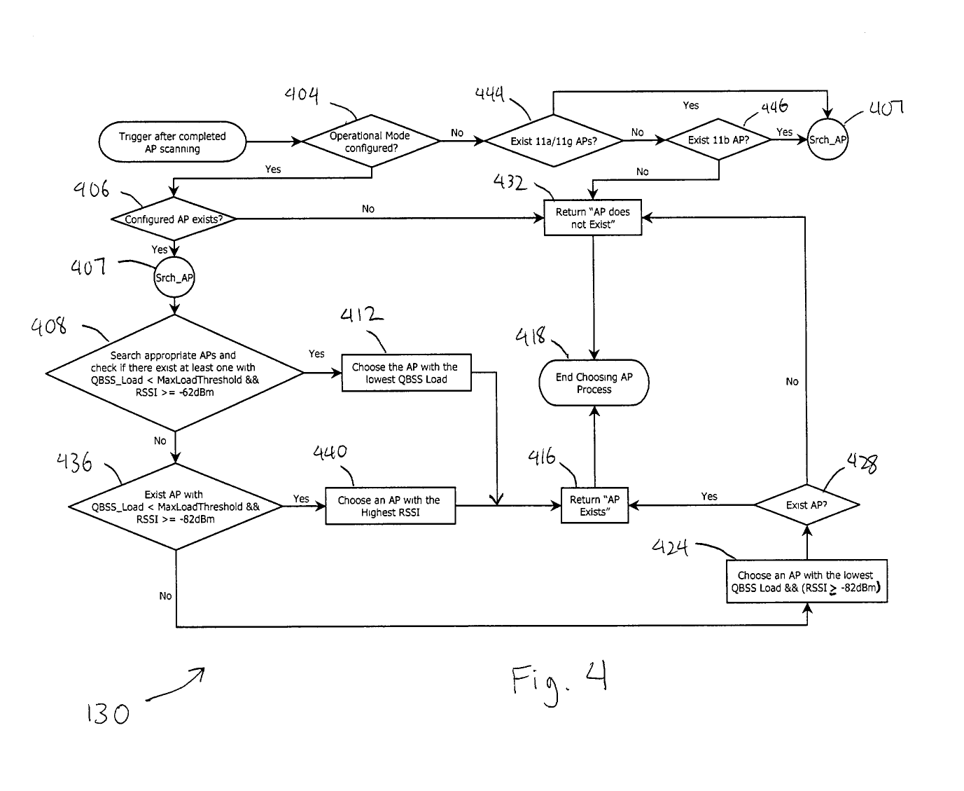

FIG. 4 is a flow chart of one embodiment of AP selection process 130 of FIG. 1, which is initiated after the active scanning in step 122 or the passive scanning in step 126 is completed. In step 404, the wireless station first determines if an operational mode has been configured, i.e., for 802.11 (a), 802.11 (b), or 802.11 (g) networks. If the network is configured for a specific operational mode, the wireless station, in step 406, determines if there any configured APs in its scanned list. If not, then the result of the AP selection indicates that no AP was found or no suitable AP exists in step 432, and the AP selection process ends in step 418.

However, if there is at least one configured AP, the station begins a search, in step 407, of its list of scanned APs for the best access point to associate with. First, in step 408, the station compares all the RSSI value and channel loading information (or QBSS_Load value) from its scanned list for each of the APs in the appropriate configured mode. From this stored information, the wireless station searches for APs that satisfy the following two conditions:

QBSS_Load<MaxLoadThreshold (2)

RSSI≧−62 dBm (3)

MaxLoadThreshold is the optimum performance threshold the particular wireless station can tolerate while still meeting its quality of service (QoS) requirements. Note that different stations may have different maximum threshold values, since each may have different QoS requirements.

If there is at least one access point meeting conditions (2) and (3), the wireless station selects the AP with the lowest channel loading (or QBSS_Load value) in step 412. Then, in step 416, the result of the AP selection indicates that an AP was found or a suitable AP exists and the AP selection process ends in step 418.

If no AP exists that satisfies conditions (2) and (3), the wireless station, in step 436, determines if an AP exists that satisfies the following two conditions:

QBSS_Load<MaxLoadThreshold (2)

RSSI≧−82 dBm (4)

Note that the condition for QBSS_Load remains unchanged, while the minimum threshold for RSSI is increased from −62 dBm to −82 dBm.

If at least one AP exists from step 436, the wireless station selects the AP with the highest RSSI value in step 440. Then, the result of step 416 indicates that a suitable AP exists, and the AP selection process ends in step 418. However, if there are no APs satisfying conditions (2) and (4) in step 436, the wireless station selects the AP having the lowest QBSS_Load number and meeting the requirement of condition (4) (reproduced below) in step 424.

RSSI≧−82 dBm (4)

Step 428 then determines if there are any APs selected from step 424. If there are none, then the result of the AP selection indicates that no AP was found or no suitable AP exists in step 432 and the AP selection process ends in step 418. However, if there is an AP that satisfies condition (4), the one with the lowest QBSS_Load number is selected, and the result of the AP selection indicates, in step 416, that a suitable AP has been found. The AP selection process then ends in step 418.

Returning to step 404, if no operational mode is configured, then the wireless station searches its scanned list to determine first in step 444 if there are any 802.11 (a) and 802.11 (g) APs on the list, and if not, then in step 446 if there are any 802.11 (b) APs on the list. If there is at least one 802.11 (a), 802.11 (b), or 802.11 (g) AP that exists, the wireless station begins to search, in step 407, for appropriate APs. First, the station searches the appropriate APs for ones that meet conditions (2) and (3) (in step 408). If there are none, then the search continues for APs that meet conditions (2) and (4) (in step 436). Processing continues as described above to determine if a suitable access point is found.

If there are no 802.11 (a), 802.11 (b), or 802.11 (g) APs in the wireless station's scanned list (as determined in steps 444 and 446), then the search result returns an indication, in step 432, that no suitable AP was found. The AP selection process then ends in step 418.

Referring back to FIG. 1, once the AP selection process ends, the wireless station determines, in step 134, whether a suitable AP was found in step 130. If no APs were found in the AP selection process, the wireless station, in step 142, sends an error message to the application indicating that no APs were found, and no connection between the wireless station and any AP in the BSS can be made at the time. However, if an AP exists, then the wireless station attempts to associate with the selected AP in step 138.

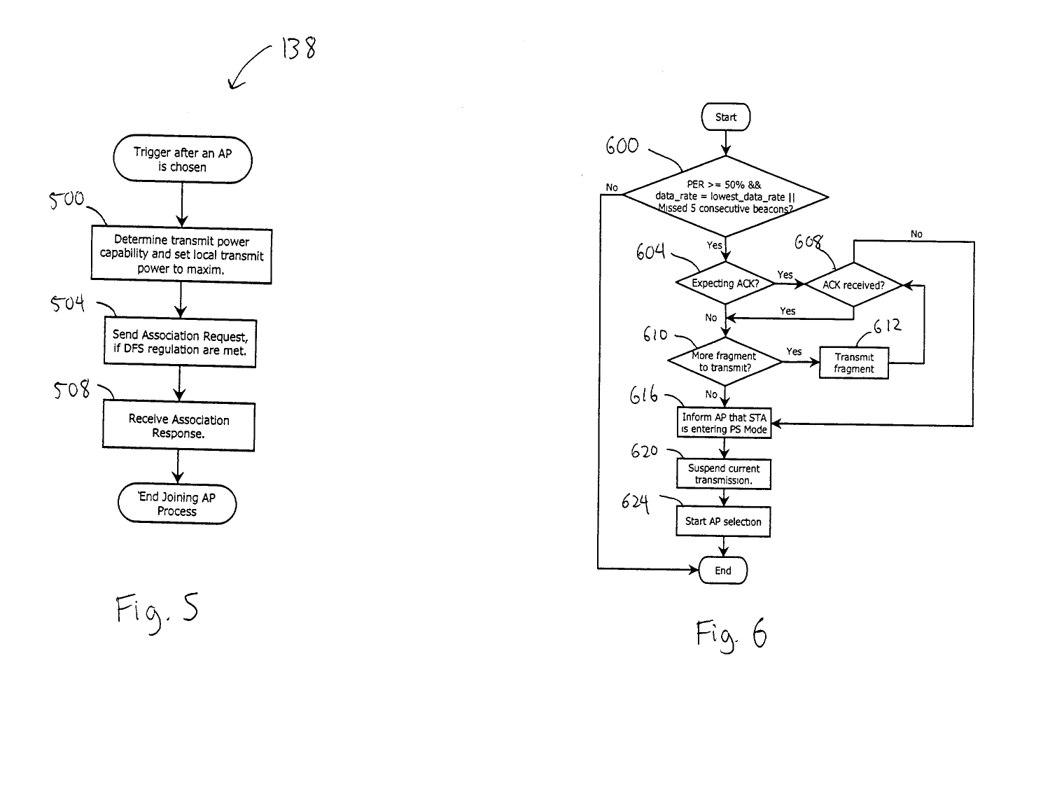

FIG. 5 is a flow chart of one embodiment of AP association process 138 of FIG. 1. This process is initiated if an AP was found during the selection process. In step 500, the wireless station determines its transmission power capability, and sets local transmission power to the AP at the maximum. The wireless station then sends an association request, in step 504, to the address of the selected AP if the DFS (Dynamic Frequency Selection) regulation is met. In step 508, the wireless station receives the association response from the AP and joins the network. Before the association response is sent, the AP must first acknowledge and accept the association request before the connection can be created. Once the communication channel is set up, data transmission between the wireless station and AP commences.

However, during the data transmission process, the channel or network loading for the AP may have become very high, e.g., by additional wireless stations associating with that AP, resulting in unacceptable levels of network throughput. Also, the received signal strength from the AP may have decreased to the point that reliable communication between the station and AP is no longer possible. Once a wireless station associates with an AP, the station may move out of coverage area of that AP. In such situations, the wireless station will need to find another AP to associate with. Thus, the wireless station triggers an AP selection-during-roaming process to find an AP capable of providing the best available performance.

The AP selection-during-roaming process is similar to the initial AP selection process of FIGS. 1-5, except that after an AP selected, the wireless station is required to transmit a disassociation request to the current AP before joining the new AP. This is because during roaming, the wireless station maintains connection with its current AP.

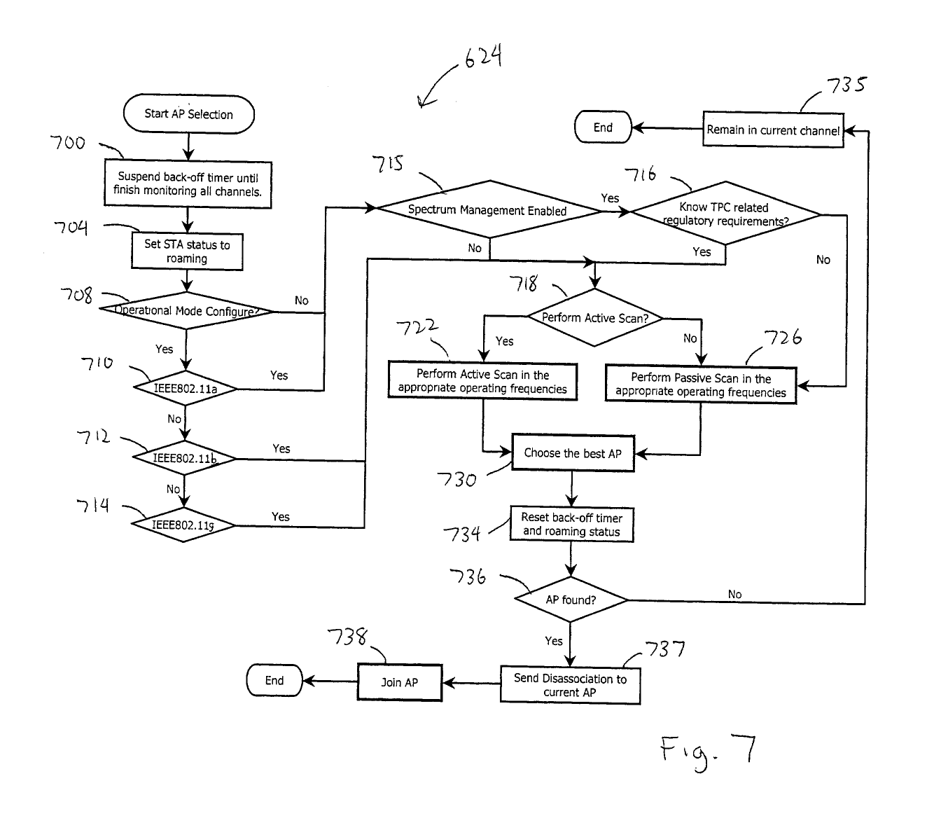

FIGS. 6-7 are flow charts showing one embodiment of an AP selection-during-roaming process. FIG. 6 is a flow chart showing a general overall process of the algorithm. In step 600, the wireless station determines whether any one of the following three conditions is satisfied:

PER≧50% and Data Rate=lowest_data_rate (5)

CurrentLoad≧MaxLoadThreshold (6)

Number of consecutive beacons missed≧5 (7)

Lowest_data_rate is the lowest supported data rate for the corresponding AP. For 802.11 (a), the lowest_data_rate is 6 Mbps, and for 802.11 (b) and 802.11 (g), the lowest_data_rate is 1 Mbps. Condition (5) will allow the station to search for another AP, if other conditions are met, when the current AP cannot provide the desired performance (e.g., PER≧50%) even at its lowest data rate. CurrentLoad is the most recent loading information obtained from the beacon or the probe response. For each station, MaxLoadThreshold will most likely be the same as the one used in initial requirements during the time between initial AP selection and roaming. Basically, MaxLoadThreshold is whatever value the station has stored in this variable when it performs AP selection. PER or Packet Error Rate, as referred herein, is calculated as follows:

$$PER = \frac{Num\_ACK \_Timeout}{Num\_Frames \_Tx} \qquad ( 8 )$$

where Num_ACK_Timeout is the number of times the station does not receive acknowledgements (ACKs) for the transmitted frames, and Num_Frames_Tx is the total number of frames transmitted. PER ranges between 0 and 1, or equivalently between 0 and 100%.

So, if the packet error rate reaches or exceeds 50% when the data rate is at the lowest (6 Mbps for 802.11 (a), 1 Mbps for 802.11 (b) and 802.11 (g)) or the current channel loading reaches or exceeds the optimal performance threshold or the wireless station misses 5 consecutive beacons transmitted by the AP, then the AP selection-during-roaming process is started. Otherwise, the wireless station remains associated with its current AP.

Once it is determined that the wireless station needs to search for a new AP, the wireless station checks, in step 604, whether it is currently expecting an ACK from the AP. If the station is expecting an ACK, and an ACK is received, in step 608, the station checks if it has additional fragments to transmit, in step 610. Fragments are smaller MAC level frames, which combine to form a higher level data or management frames. Fragments can improve the reliability of the overall transmission due to the improved probability of successful transmission of the smaller frames. Each fragment has a header, frame body, and CRC and is sent as an independent transmission, with a separate acknowledgment. If there are more fragments to transmit, the wireless station transmits the fragment in step 612. The station then checks if it has received an ACK in step 608. The wireless station continues transmitting fragments as long as there are more fragments to send and the station receives ACKs from each transmission.

Once the wireless station stops receiving expected ACKs (steps 604 and 608), has no more fragments to transmit (step 610), or transmits a fragment without receiving an ACK (steps 612 and 608), the station informs its current AP, in step 616, that the station is entering a “power saving” mode. In response to the message, the AP halts all transmissions to the station. The station also ceases all communication, in step 620, and begins the AP selection-during-roaming in step 624.

FIG. 7 is a flow chart showing one embodiment of AP selection-during-roaming process 624 of FIG. 6. AP selection process 624 is similar to initial AP selection process 100 of FIGS. 1-5. First, in step 700, the wireless station suspends its back-off timer until all frequency channels have been searched. The back-off timer is suspended so that the wireless station will not transmit data during the time it is roaming and searching for a new AP. After the back-off timer is suspended, the status of the wireless station is set for to “roaming in step 704. The station then checks if an operational mode has been configured (in step 708), and if so, whether the mode is 802.11 (a), 802.11 (b), or 802.11 (g) (in steps 710, 712, and 714, respectively). After checking configuration mode or if no mode is configured, the wireless station checks whether spectrum management is enabled and/or the TPC related regulatory requirements are known in steps 715 and 716, respectively. Steps 708, 710, 712, and 714 718 are the same as steps 108, 110, 112, 114-118 of FIG. 1 and are thus not discussed here in detail.

Depending on the results in steps 715 and/or 716, the wireless station either first determines the scanning mode in step 718 and performs the appropriate scan (active in step 722 or passive in step 726) or directly performs a passive scan in step 726. The scan, either active or passive, is performed at the appropriate operating frequencies to acquire the necessary information for AP selection. Active scan step 722 and passive scan step 726 are the same as active and passive scans 122 and 126 of FIGS. 2 and 3, respectively. Thus, details can be referenced to the discussion above. After the scanning step, in which a scanned list of APs is created, the wireless station chooses the best AP from that list in step 730. AP selection step 730 is the same as selection step 130 of FIG. 4. After AP selection, in step 734, the wireless station resets its back-off timer and roaming status. Next, in step 736, the station determines if an AP was chosen in step 730. If not, the station remains with its current AP in step 735.

However, if an AP was found in step 730, the wireless station transmits a disassociation request to its current AP in step 737. The disassociation service is used to terminate an association between an AP and a wireless station. After the wireless station disassociates with the AP, it must now re-associate itself with the newly selected AP. By using the re-association service, the wireless station provides information to the AP to which it will be associated and information pertaining to the AP which it will be disassociated. This allows the newly associated AP to contact the previously associated AP to obtain frames that may be waiting there for delivery to the wireless station as well as other information that may be relevant to the new association. The-wireless station then joins with the newly selected AP in step 738, which is the same as step 138 of FIG. 5. At this point, the wireless station can begin data transmission with its new AP.

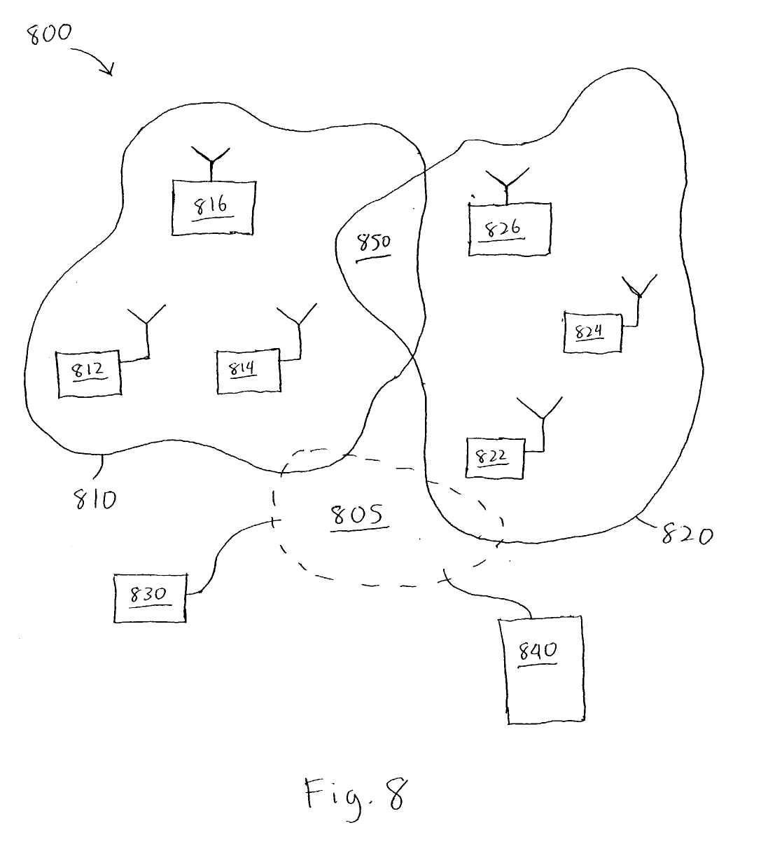

The algorithms of the present invention can be implemented in a variety of wireless communication systems that support QoS and seeks to optimize network performance. Potential applications include wireless LANs, wireless MANs, wireless HANs, and wireless PANs. FIG. 8 is a simplified diagram of a portion of a WLAN network 800 that is conformant to 802.11. In FIG. 8, an Ethernet LAN 805 includes a first BSS 810 and a second BSS 820, a workstation 830 (e.g., a desktop computer), and a fileserver 840. BSS 810 has two wireless stations 812 and 814 and an access point 816, and BSS 820 has two wireless stations 822 and 824 and an access point 826. BSS 810 and BSS 820 have an overlapping coverage area 850. Data is transmitted between a wireless station and workstation 830 and/or fileserver 840 through an access point. If wireless station 812 moves or roams into area 850, its connection with access point 816 may degrade to the point that it needs to try and re-associate with a new access point. Existing software in 802.11 wireless stations can be easily modified by those skilled in the art to allow wireless station 812 to select a new access point according to the present invention.

AP selection according to the present invention provides an improved algorithm that utilizes information contained in the beacon or probe response frame in addition to the RSSI value. By also using a channel loading value, an AP can be selected that may result in higher network performance, e.g., improved throughput and/or higher communication quality, than with algorithms using just RSSI values. Further, channel loading values calculated without having to estimate the data rate during idle periods where no data is being received provides a better indication of channel utilization.

For example, a wireless station can associate with one of three access points AP₁, AP₂, or AP₃. Table 1 below lists the channel loading and RSSI value for each AP.

TABLE 1

| Access Point | Channel loading | RSSI |
|---|---|---|
| AP₁ | 85% | −50 dBm |
| AP₂ | 50% | −55 dBm |
| AP₃ | 5% | −60 dBm |

With conventional algorithms that only use RSSI values, the station will associate with AP₁, even though it has the highest channel loading or utilization. However, because of the high channel loading, the station may experience a very low performance and will start searching for other APs to associate with. Thus, in this case, a station will find itself consuming most of the time searching for APs instead of transmitting useful data. With the present invention, the wireless station would select AP₃, instead of AP₁. Even though the signal strength is the lowest of the three, it is still high enough to sustain acceptable communication levels. Further, the lower channel utilization provides the station with higher performance than with AP₁.

The above-described embodiments of the present invention are merely meant to be illustrative and not limiting. It will thus be obvious to those skilled in the art that various changes and modifications may be made without departing from this invention in its broader aspects. For example, the above description uses specific thresholds, such as −62 dBm, −82 dBm, 5, and 50%. Other thresholds are also suitable with use for this invention, depending on various factors, such as performance requirements and communication quality. Therefore, the appended claims encompass all such changes and modifications as fall within the true spirit and scope of this invention.

We claim:

1. A method for selecting an access point (AP) in a wireless network, comprising:
(a) measuring a received signal strength indicator (RSSI) and obtaining a channel loading indicator for each AP in each frequency channel;
(b) setting a first and a second threshold for the RSSI and a third threshold for the channel loading indicator, wherein the second threshold is less than the first threshold;
(c) selecting the AP with the lowest channel loading indicator if an AP exists with an RSSI greater than or equal to the first threshold and a channel loading indicator less than the third threshold;
(d) if no AP is selected in (c), selecting the AP with the highest RSSI if an AP exists with an RSSI greater than or equal to the second threshold and a channel loading indicator less than the third threshold; and
(e) if no AP is selected in (d), selecting the AP with the lowest channel loading indicator if an AP exists with an RSSI greater than the second threshold.

2. The method of claim 1, wherein the channel loading indicator is the percentage of time an AP is busy transmitting or receiving data during a reporting interval.

3. The method of claim 2, wherein the reporting interval is a beacon interval.

4. The method of claim 1, the obtaining is by a passive scan or an active scan.

5. The method of claim 1, wherein the network is 802.11 conformant.

6. The method of claim 5, wherein the operational mode is configured.

7. The method of claim 6, wherein the operational mode is selected from the group consisting of 802.11 (a), 802.11 (b), and 802.11 (g) modes.

8. The method of claim 5, wherein the operational mode is not configured.

9. The method of claim 8, wherein, in steps (c) and (d), the AP is selected from only 801.11 (a) or 802.11 (g) APs.

10. The method of claim 8, wherein, in steps (© and (d), the AP is selected from only 802.11 (b) APs.

11. The method of claim 1, wherein the first threshold is-62 dBm, and the second threshold is −82 dBm.

12. A method of selecting, from a plurality of access points in a wireless network, an access point by a wireless station, comprising:
transmitting, by the access points, measuring signal strength information and obtaining channel loading information for each access point;
measuring, by the wireless station, the signal strength information for each access point;
receiving channel loading information for each access point; and
selecting an access point based on the signal strength and channel loading information.

13. The method of claim 12, wherein the channel loading information for the selecting is the percentage of time an access point is busy transmitting dr receiving data during the reporting interval.

14. The method of claim 12, further comprising setting a first and a second threshold for the signal strength information and a third threshold for the channel loading information, wherein the second threshold is less than the first threshold.

15. The method of claim 14, wherein the selecting comprises:
(a) selecting the access point with the lowest channel loading if an access point exists with a signal strength greater than or equal to the first threshold and a channel loading less than the third threshold;
(b) if no access point is selected in (a), selecting the access point with the highest signal strength if an access point exists with a signal strength greater than or equal to the second threshold and a channel loading less than the third threshold; and
(c) if no access point is selected in (b), selecting the access point with the lowest channel loading if an access point exists with a signal strength greater than the second threshold.

16. A wireless network, comprising:
a plurality of access points, each access point comprising a transmitter for sending channel loading information; and
a plurality of wireless stations within communication range of the access points, wherein each wireless station comprises:
a receiver for measuring the signal strength and receiving channel loading information from the access points; and
a processor for selecting an access point based on the signal strength and channel loading information.

17. The wireless network of claim 16, wherein the processor is configured to calculate, from the channel loading information received from the access point, the percentage of time the access point is busy transmitting or receiving data during a reporting interval.

18. The wireless network of claim 16, wherein the access points and wireless stations are conformant to IEEE 802.11 standard.

19. The wireless network of claim 17, wherein the processor is configured to set a first and a second threshold for the signal strength information and a third threshold for the channel loading information, wherein the second threshold is less than the first threshold.

20. The wireless network of claim 19, wherein the processor is configured to (a) select the access point with the lowest channel loading if an access point exists with a signal strength greater than or equal to the first threshold and a channel loading less than the third threshold; (b) if no access point is selected in (a), select the access point with the highest signal strength if an access point exists with a signal strength greater than or equal to the second threshold and a channel loading less than the third threshold; and (c) if no access point is selected in (b), select the access point with the lowest channel loading if an access point exists with a signal strength greater than the second threshold.
